(19) United States
(12) Patent Application Publication
(10) Pub. No.: US 2009/0231155 A1
(43) Pub. Date: Sep. 17, 2009

(54) EMERGENCY/HAZARD WARNING SYSTEM

(76) Inventor: Henry Kovarnik, Southlake, TX (US)

Correspondence Address: BANOWSKY &LEVINE, P.C, 12001 N. CENTRAL EXPRESSWAY, SUITE 790, DALLAS, TX, 75243, US

(21) Appl. No.: 12/048,397

(22) Filed: Mar. 14, 2008

(51) Int. Cl. G08B 7/00; G08B 21/02

(52) U.S. Cl. 340/692; 340/691.7

(57) ABSTRACT

An emergency/hazard warning system which provides a warning of a dangerous roadside condition to oncoming traffic by means of an elevated flare, reflector, emergency light, or other safety signal, but which also meets an essential safety need by utilizing a position-responsive switch or other means for energizing a battery powered audible alarm. The battery powered audible alarm is energized when a predetermined perimeter around the roadside dangerous condition is breached. This provides a system for warning those individuals involved in a roadside dangerous condition, such as a disabled vehicle, road work, and the like, that the perimeter has been breached so that evasive action can be taken to prevent personal injury or property damage. Either a single unit can be deployed to established the required perimeter or multiple units may be daisy chained together with a retractable cord to provide a more comprehensive barrier. The emergency/hazard warning system is light weight and compact. It easily stores in the trunk or other storage compartment of a motor vehicle. The emergency/hazard warning system can be easily deployed in the event of a road side emergency to lesson the risk of injury to those involved in a roadside emergency as well as oncoming traffic.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Although several devices have been designed for use as roadside hazard warning systems, most of such devices are limited to providing a warning to approaching traffic that a dangerous condition exists ahead. The present invention also provides a warning to oncoming traffic by means of a flare, reflector, emergency light, or the like. However, the present invention also meets an essential safety need not otherwise addressed by the prior art by utilizing a position-responsive switch or other means for energizing a battery powered audible alarm to provide a system for warning those individuals involved in a side of the road dangerous condition that an oncoming vehicle has breached a predetermined perimeter and may pose an immediate threat to those on the side of the road. This allows those on the side of the road to take evasive action to prevent personal injury or property damage as a result of the condition which caused the breach of the perimeter, i.e. an oncoming vehicle, etc. Either a single unit can be deployed to establish the required perimeter or multiple units may be daisy chained together with a retractable cord to provide a more comprehensive barrier.

### BRIEF SUMMARY OF THE INVENTION

The present invention relates to an emergency/hazard warning system for roadside use that is portable, collapsible for easy storage in the trunk of an automobile, and which can be set up quickly to indicate the safety boundary of a restricted area, for example a roadside area where a stalled car is off the road, or next to the scene of an accident, or alongside a work area where a highway section or bridge is being repaired, or where debris has spilled onto the right-of-way.

The system provides early warning to operators of approaching vehicles to be on the watch for hazardous road conditions, slow moving traffic, as well as the presence of emergency response medical personnel, police, tow trucks, service trucks and construction workers. The system also provides early warning to persons working within a restricted or barricaded area that the safety boundary has been encroached, possibly by a motor vehicle.

### BRIEF DESCRIPTIONS OF THE DRAWINGS

FIG. 1 is a general drawing of one preferred embodiment of the invention.

FIG. 2 is a detailed drawing of the stand 2.

FIG. 3 is a detailed drawing of the hub 8.

FIG. 4 is a general drawing of one preferred embodiment of the invention.

FIG. 5 depicts the deployment of one embodiment of the invention in a typical road side scenario.

FIG. 6 depicts the deployment of another embodiment of the invention in a typical road side scenario.

### DETAILED DESCRIPTION OF THE INVENTION

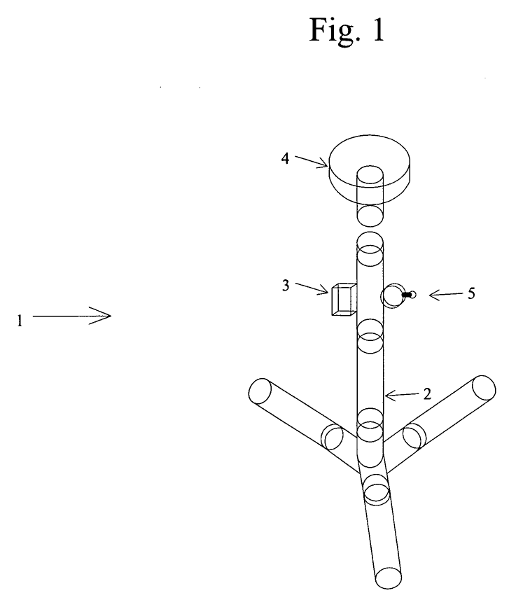

The emergency/hazard warning system is illustrated generally in FIG. 1 and is identified by the number 1. As is depicted in FIG. 1, the emergency/hazard warning system 1 has a collapsible stand 2, a battery powered audible alarm 3, and a battery powered flashing light 4. In a preferred embodiment, the emergency/hazard warning system 1 also has a retractable cord 5. Additionally, the emergency/hazard warning system 1 utilizes a means for energizing the battery powered audible alarm 3 in the event that the emergency/hazard warning system is tilted or tipped over. The means for energizing the battery powered audible alarm 3 can be any one or more of a number of devices such as a position-responsive switch, an inertia switch or any other similar device which would be well known to one skilled in the art.

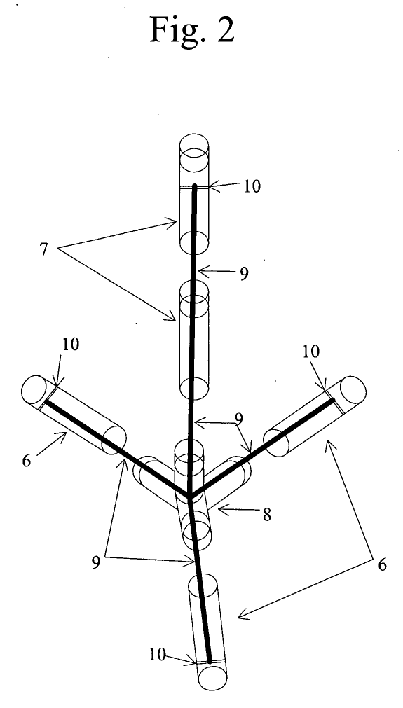

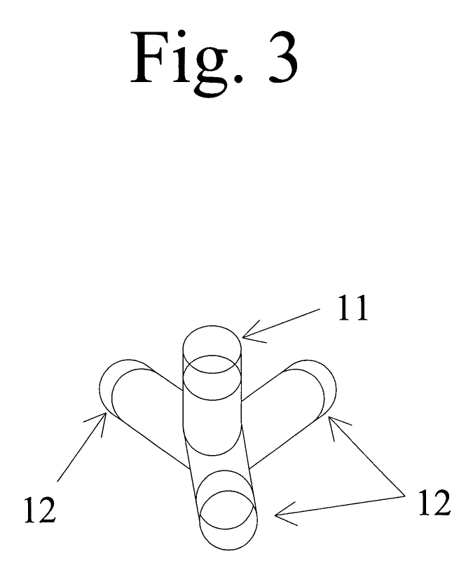

The collapsible stand 2 is further illustrated in FIG. 2. The collapsible stand 2 has three legs 6, one or more vertical members 7, and a hub 8 which connects the legs 6 to each other and to the vertical members 7. In a preferred embodiment of the invention, the legs 6 and the vertical members 7 are affixed to each other by internal elastic cords 9 which pass through a vertical connection 11 (FIG. 3) and leg connections 12 (FIG. 3) in the hub 8 and such elastic cords 9 are affixed to the legs 6 and a vertical member 7 by internal pins 10.

The hub 8 is further illustrated in FIG. 3. In a preferred embodiment of the invention, the hub 8 has a vertical connection 11 for a the vertical members 7 and three leg connections 12 for the legs 6 wherein the adjacent leg connections 12 are at an angle of approximately 120 degrees from each other and each leg connection 12 is at an angle of between 90 degrees and 135 degrees from the vertical connection 11. It is understood that the angle of the leg connections 12 to the vertical connection 11 and the relationship between the length of the legs 6 and the length of the vertical members 7 can be altered to achieve varying degrees of stability for the emergency/hazard 1 warning system. In a preferred embodiment, the length of the vertical members 7 is approximately three times the length of each of the legs 6 and the angle between the leg connections 12 and the vertical connection 11 is approximately 120 degrees. However, it should be understood that, if a particular application requires greater stability, the length of the vertical members 6 can be reduced relative to the length of each of the legs 6 and/or the angle of the leg connections 12 to the vertical connection 11 can be reduced. Likewise, if a particular application requires less stability, the length of the vertical members 7 can be increased relative to the length of each of the legs 6 and/or the angle of the leg connections 12 to the vertical connection 11 can be increased.

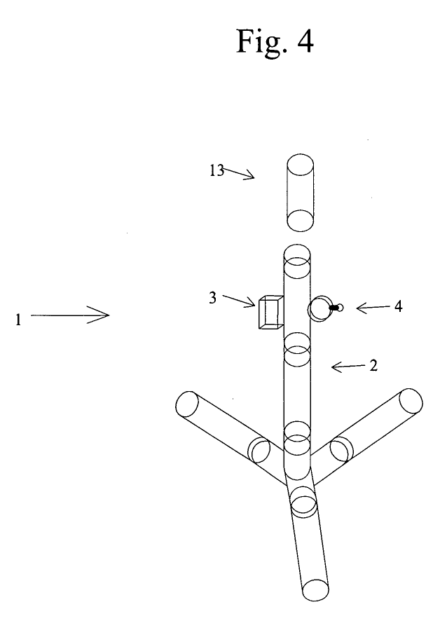

Another preferred embodiment of the emergency/hazard warning system 1 is illustrated generally in FIG. 4. In this embodiment of the invention, a means for alerting traffic 13 is affixed to the top of the vertical members 7. The means for alerting traffic 13 can be any type of device capable of alerting the operators of vehicular traffic to the presence of an emergency situation such as pyrotechnic flares, reflectors, emergency lights, and so forth, all of which would be familiar to one skilled in the art.

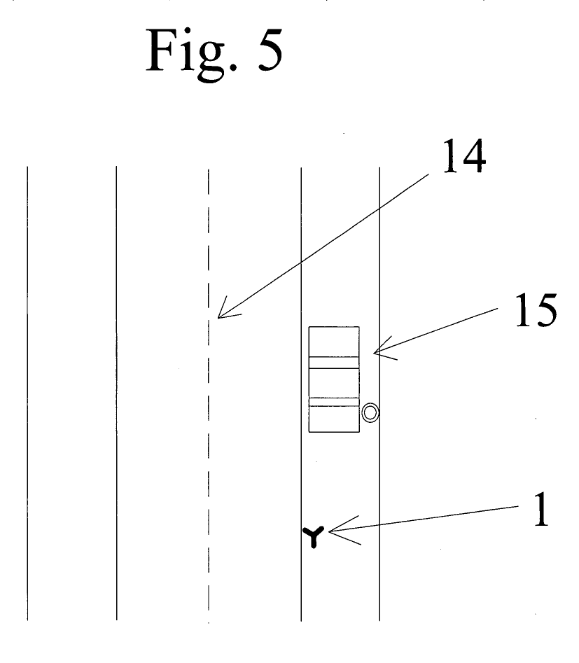

FIG. 5 depicts the deployment of a single unit of the emergency/hazard warning system 1 in a typical roadside scenario. In this embodiment of the invention, the emergency/hazard warning system 1 is positioned on the side of a roadway 14 behind an emergency situation 15 relative to the flow of traffic on the side of the roadway 14 where the emergency situation 15 exists. The emergency situation 15 could be any one or more of a number of situations including, without limitation, a disabled vehicle, a work crew, a roadside obstacle or debris. The emergency/hazard warning system 1 is placed so as to provide an early warning to operators of approaching vehicles to be on the watch for the emergency situation 15. The emergency/hazard warning system 1 also provides early warning to persons working within the emergency situation 15 that the safety boundary has been encroached, possibly by a motor vehicle, in the event the emergency/hazard warning system 1 is tilted or tipped over.

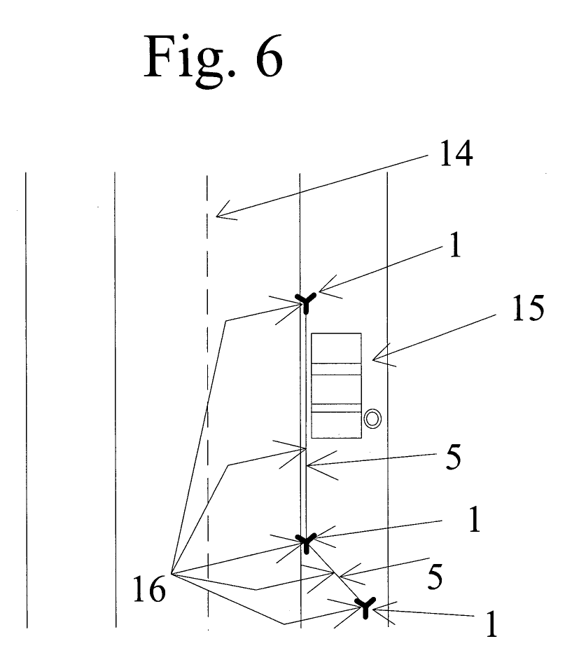

FIG. 6 depicts the deployment of multiple units of the emergency/hazard warning system 1 in a typical roadside scenario. In the depicted embodiment of the invention, three units of the emergency/hazard warning system 1 are linked together by their respective retractable cords 5, so as to form a barrier 16 between the roadway 14 and an emergency situation 15. The emergency situation 15 could be any one or more of a number of situations including, without limitation, an accident, a disabled vehicle, a work crew, a roadside obstacle or debris.

The emergency/hazard warning system 1 is designed so that it can be disassembled into a small package which will easily fit inside the trunk or other storage area of a motor vehicle. The emergency/hazard warning system 1 is deployed by affixing the legs 6 to the leg connections 12 of the hub 8, by affixing the vertical members 7 to each other and to the vertical connection 11 of the hub 8, by affixing the battery powered audible alarm 3 to one of the vertical members 7, and by affixing the battery powered flashing light 3 or the means for alerting traffic 13 to the top of the topmost vertical member 7. One or more units of the emergency/hazard warning system 1 are then deployed around an emergency situation 15 and, if more than one unit is deployed, the separate units are connected to each other in a daisy chain fashion with the retractable cords 5 so as to create a barrier 16 around the emergency situation 15.

The emergency/hazard warning system 1, once deployed, alerts oncoming traffic to the existence of an emergency situation. Additionally, in the event the barrier 16 is crossed the retractable cords 5 will cause one or more of the units of the emergency/hazard warning system 1 to tilt or tip over so that the position-responsive switch or other means for energizing the battery powered audible alarm will cause the battery powered audible alarm to become energized and sound an audible warning to those within the barrier 16. Likewise, if only a single unit of the emergency/hazard warning system 1 is deployed, in the event the unit is tilted or tipped over, the position-responsive switch or other means for energizing the battery powered audible alarm will cause the battery powered audible alarm to become energized and sound an audible warning to those within the emergency situation 15.

What is claimed is:

1. An emergency/hazard warning system comprising a collapsible stand, a battery powered audible alarm and a means for energizing said battery powered audible alarm in the event said emergency/hazard warning system is tilted or tipped over.

2. The emergency/hazard warning system of claim 1 wherein said collapsible stand is further comprised of three legs, a hub and one or more vertical members.

3. The emergency/hazard warning system of claim 2, wherein said legs and said vertical members are affixed to said hub by internal elastic cords.

4. The emergency/hazard warning system of claim 2, wherein the angle between said legs and the adjacent of said legs is 120 degrees.

5. The emergency/hazard warning system of claim 2, wherein the angle between said legs and said vertical members is 120 degrees.

6. The emergency/hazard warning system of claim 2, wherein the angle between said legs and said vertical members is between 90 degrees and 135 degrees.

7. The emergency/hazard warning system of claim 2, wherein said collapsible stand is further comprised of a retractable cord.

8. The emergency/hazard warning system of claim 1 further comprising a means for alerting traffic affixed to the top of said collapsible stand.

9. The emergency/hazard warning system of claim 8 wherein said means for alerting traffic is a pyrotechnic flare.

10. The emergency/hazard warning system of claim 8 wherein said means for alerting traffic is comprised of one or more reflectors.

11. The emergency/hazard warning system of claim 8 wherein said means for alerting traffic is comprised of one or more lights.
